(19) United States
(12) Patent Application Publication
(10) Pub. No.: US 2008/0258924 A1
(43) Pub. Date: Oct. 23, 2008

(54) FIRE ALARM SYSTEM

(76) Inventor: J. Darryl Moss, Alpharetta, GA (US)

Correspondence Address: GEORGE R. REARDON, 3356 STATION COURT, LAWRENCVILLE, GA, 30044, US

(21) Appl. No.: 11/738,253

(22) Filed: Apr. 20, 2007

(51) Int. Cl. G08B 25/00

(52) U.S. Cl. 340/577; 340/540; 340/584; 340/628; 340/632

(57) ABSTRACT

A fire alarm system is disclosed where the unit detectors are addressable and in communication with other unit detectors located within a particular unit and are in communication with building detectors such that when one unit detector activates, all the other unit detectors in that unit also activate causing communication with the building core detectors and alerting the control room as to the exact location of the alarm condition.

### FIELD OF THE INVENTION

The present invention relates generally to fire alarm systems, and more particularly to a fire alarm system for commercial and residential structures.

### BACKGROUND OF THE INVENTION

The invention pertains in general to fire alarm systems, and in particular to a fire alarm system employing a 120 volt ionization/photoelectric smoke/heat detector with an addressable dip switch, or equivalents thereof.

With fire alarm systems, the design of the overall goals, general system type, and integration into the other facility systems (active fire suppression, HVAC, lighting, electrical power, fire barriers, etc.) is performed by competent engineers with experience in fire protection, who are licensed within the geographical area of practice, such as a U.S., State or a Canadian Province. This is done in conjunction with the Architect's design team during the design phase of the building project. The detailed component selection and layout is provided by a technician as hired by the contractor during the construction phase. In the United States, that person is usually certified for fire alarm design by the National Institute for Certification of Engineering Technologies (NICET).

The design is typically provided in compliance with the model building codes having jurisdiction in that area. In the United States, NFPA 72, The National Fire Alarm Code is usually used for the installation methods, testing and maintenance. Property insurance company recommendations are also sometimes incorporated.

Extensions of existing systems are done considering the originally installed fire alarm system, and more than likely will be proprietary to match the existing equipment.

A fire alarm system is composed of components which can be classified into the following categories.
Initiating Devices—these devices either sense the effects of a fire, or are manually activated by personnel, resulting in a signal to the fire alarm panel. Examples are heat detectors, smoke detectors, manual pull stations, and sprinkler pressure or flow switches.
Main Fire alarm control (panel)—this is the central brain of the overall system, which coordinates the signals and resultant actions of the system.
Fire Alarm Control Unit (Panel)—any panel providing required functions, and has inputs and outputs. NAC Power booster panels are the most common example.
Power supply—because one of the fire alarm system objectives is life safety, fire alarm system power supplies are redundant, and relatively very reliable as compared to electronic or electrical systems of similar complexities (e.g., HVAC control systems). Primary supply- Commercial light and power. Back-up/secondary supply—Usually sealed, lead-acid batteries. NAC power supplies for additional notification appliances beyond the original capability of the FACP. Generators are permitted under strict rules.
Notification appliances—these devices provide stimuli for initiating emergency action and provide information to users, emergency response personnel, and occupants. Examples are bell, horn, speaker, light, or text display that provides audible, tactile, or visible outputs.
Signaling line circuits (SLC)—the wiring which carries data information.
Supervisory signals—detecting devices and signaling to indicate a condition in fire protection systems which is not normal and could prevent the fire protection system from functioning as intended in the event of a fire. An example is a closed valve which controls the water supply to a fire sprinkler system. This does not indicate the failure of a component or subsystem of the fire alarm system.
Trouble signal—signaling to indicate a wiring fault. Sometimes specific components or features of the fire alarm system, f which could prevent the fire alarm or fire suppression system from functioning as intended. An example is a disconnected wire at a heat detector.
Remote annunciation—A usually alpha-numeric display (may be graphic) that indicates where in the building the alarm originated. It may also indicate the type of device. Used by emergency personnel for locating the fire quickly. Sometimes these will contain some control functions such as alarm silence and alarm reset. Must be key or keypad controlled.

Fire alarm systems have devices connected to them to detect the fire/smoke or to alert the occupants of an emergency. Below is a list of common devices found on a fire alarm.
Manual pull stations/manual call points—Devices to allow people to manually activate the fire alarm. Usually located near exits. Also called “manual pull boxes”.
Smoke detectors—Spot type: Photoelectric and Ionization; Line type: Projected Beam Smoke Detector; Air-Sampling type: Cloud Chamber
Water Flow Switches—Detect when water is flowing through the fire sprinkler system
Rate-of-Rise and Thermostat (heat) Detectors—Detect heat changes
Valve Supervisory Switch—Indicates that a fire sprinkler system valve that is required to be open, is now closed (off-normal).
Carbon Monoxide Detectors—Detects poisonous carbon monoxide gas and usually only connected to household fire alarm systems. Very rarely, commercial systems.
Horns/Strobes—Visual and Audible devices to alert people of system activation.
Magnetic Door Holder—Doors are allowed to close when the fire alarm is activated.

An audio evacuation system or voice evacuation system is a type of fire alarm notification system. In addition to, or in place of, sirens, horns, bells, and alarm tones, an audio evacuation system plays a voice message with evacuation instructions. These messages can be customized for various types of installations, and multi-lingual capabilities are usually available.

The rationale behind audio evacuation systems is, though conventional fire alarm notification devices alert occupants of a building of the presence of an emergency, they do not provide detailed information to the occupants, such evacuation routes or instructions. The problem lies in buildings where there are a large amount of frequently changing occupants who are not necessarily familiar with the locations of emergency exits or stairwells. These types of buildings are designated in model building codes as “areas of assembly”, such as buildings with a capacity of 300 or more people, but voice evacuation rules usually only apply when the occupant load exceeds 1000. Areas of assembly include churches, movie theaters, auditoriums, department stores, restaurants, shopping malls, and museums. Additionally, such a system is usually integrated with a fire telephone or paging system, which permits the fire department or building manager to give specific evacuation instructions pertinent to current conditions in real time.

Many audio evacuation systems permit multiple messages. For instance, “non fire” messages can be programmed for situations such as a hazardous material spill, gas leaks, security breaches, severe weather, etc.

In the United States, audio evacuation is now required in many jurisdictions for new structures that are classified as an area of assembly, as well as in new high rise buildings and skyscrapers. Retrofitting older structures is not required, although new fire alarm installations can be required to have audio capabilities. Similar trends are occurring in other countries as well.

Currently, in the commercial residential fire alarm industry the building fire alarm system and building unit smoke detectors are not interconnected. Typically the building fire alarm system is in the building core and the building unit smoke detectors are located in each unit (apartment, condo, hotel room, dormitory room, etc.)

The building fire alarm system uses addressable (smart) 24 volt smoke detectors that provide a description of the location to a main fire alarm control panel. The building fire alarm system is generally provided by a low voltage contractor.

The building unit smoke detectors are 120 volt non-addressable (dumb) detectors that only sound in the building unit itself. This could result in no one in the building knowing that the unit is burning, especially if the tenant isn't home, until the smoke/heat from the unit eventually billows from underneath the door leading to the building core and activates the building alarm system.

Related art that addresses these and other problems includes the following patents.

U.S. Pat. No. 4,287,515, issued to Raber et al. on Sep. 1, 1981, discloses a fire detection system which includes a single conductor pair for both supplying the energizing voltage to all of the fire detectors in the protected area and receiving back status information regarding the individual detector operation. The system provides individual, successive alarm outputs to regulate successive functions such as “evacuate the area”, “dump the fire extinguishing material”, and “call in the local fire department”, as successive ones of the detectors are alarmed. The system includes a voltage regulator for supplying a well regulated voltage to the detectors, which regulator is switched into a current limiting mode to prevent an inaccurate first alarm signal if the conductor pair is short circuited. This system also provides a trouble-indicating output signal if the system loses supply voltage or experiences a ripple voltage beyond a preset amplitude.

U.S. Pat. No. 4,394,655, issued to Wynne et al. on Jul. 19, 1983, discloses a signaling system which transmits groups of pulses to a plurality of transponders, and each transponder recognizes its address in a particular group of pulses. The group of pulses can reset the system, command a transponder to accomplish a specific function, or command the transponder to do nothing. Information returned from the transponder includes a reference voltage, which can be compared in the controller to continuously determine the margin from alarm of an associated transducer. The transponder further provides a signal identifying itself, and pulse duration signals representing analog signals received from one or more transducers associated with the transponders. No end-of-line termination is required, and branching is possible at any point along the loop.

U.S. Pat. No. 4,916,432, issued to Tice et al. on Apr. 10, 1990, discloses a smoke and fire detection system wherein a central controller transmits data to remote transponders on a voltage supply line by pulse code modulation (PCM) of the supply voltage, and the transponders communicate with the controller by pulse width modulated (PWM) current pulses over the voltage supply line. A transmitter in the controller supplies a nominal operating voltage to the transponders and transmits a data word comprising a plurality of data bits to the transponders over the line. The transmitter generates each data bit by switching the voltage supplied to the line from the nominal operating voltage to a first voltage corresponding to a first logical level or a second voltage corresponding to a second logical level. A decoder in each transponder derives the transmitted data word. The decoder detects each data bit by detecting the transition from the nominal voltage to the first or second voltages, and the decoder determines the logical level of each bit by measuring the transmitted voltage level immediately after detecting the transition. The transponder returns data to the controller in the form of data signals, each data signal having a duration based on the data to be returned. With such arrangement, the transponders do not require a clock or other timing circuitry to communicate with the controller. Also, the controller may vary the data rate or bit duration without interfering with the operation of the transponders.

U.S. Pat. No. 5,539,389, issued to Bystrak et al. on Jul. 23, 1996, discloses an apparatus and a method for addressing a plurality of spaced-apart detectors or control units in a multiple zone detection system shortens the time needed for a centrally located control element to communicate with the detectors or units. The control element addresses a plurality of units simultaneously by means of a serial bidirectional communications line. Information can be transmitted time serially to each of the addressed units which is associated with a respective time interval. The addressed units can return, time serially, on the serial communication line a plurality of indicia. The control element associates each indicium with a respective detector by means of the indicium's position relative to other returned indicia.

U.S. Pat. No. 5,598,456, issued to Feinberg on Jan. 28, 1997, discloses an integrated telephone, intercom, security and control system for a building having a plurality of units, utilizing a plurality of telephone lines located throughout the building which are connected at one end to telecommunications equipment located in the units and throughout common areas of the building. A digital switching device is connected to the other end each of the telephone lines and arranged to connect at least one of the telephone lines to at least one of another of the telephone lines or to an outside telephone line at the option of a user of the telecommunications equipment. A plurality of sensors located in the units and throughout common areas of the building are arranged for generating signals in response to conditions therein, which are then transmitted to a plurality of control modules connected to the digital switching device by at least one of the telephone lines. The control modules are further adapted to send information to a central monitoring station via the telephone lines indicative of the respective conditions and the central monitoring station is adapted to at least receive and store this information in its memory and output data indicative of the respective conditions.

U.S. Pat. No. 5,627,515, issued to Anderson on May 6, 1997, discloses a fire alarm system that includes a control unit which communicates with a plurality of spaced apart smoke detectors by a bi-directional communications link. The smoke detectors are separate from one another, and spaced apart, and are associated together in different, overlapping groups. Each group of detectors is physically arranged with the members of the group adjacent to one another in a relatively localized area. Signals from the detectors are transmitted to the control element for processing. The control element squares each of the signals for a given group, sums those signals and then takes a square root. The resultant processed value is associated with a selected one of the detectors of the group. Similar processing takes place for each of the groups. As a result of the processing, each of the detectors has associated therewith a processed smoke value which takes into account not only values received from the associated detector, but also values received from one or more adjacent detectors in a group. The processed signal values can then be compared to an alarm threshold to determine whether or not a fire condition is present.

U.S. Pat. No. 6,081,192, issued to Takahashi et al. on Jun. 27, 2000, discloses a fire alarm system which is adaptable to form a large-size fire alarm system and is capable of causing a receiving portion to quickly detect fire information from a terminal unit, or the like, if the terminal unit has been operated. In a fire alarm system in which terminal units, such as fire detectors, are connected to the receiving portion, an address is given to the terminal unit to allow detection of terminal units that have a status change, wherein system polling or the like for a specific terminal unit, such as a transmitter, among the terminal units is performed prior to performing system polling of other terminal units.

U.S. Patent Publication No. 2005/0232167 A1, inventor Gilbert et al., published on Oct. 20, 2005, discloses a telecommunications network for a high-rise Multi-Dwelling Unit (MDU). The telecommunications network eliminates much of the wiring and space required for voice, video and data services, electrical closets, security cameras, building automation, fire annunciation systems, hard-wired smoke detectors, hard-wired heat detectors, electrical meters through the use of an integrated Ethernet communication system. Additionally, a video program guide (VPG) is provided that allows a user to interact with multiple streams of video in real time. The VPG includes techniques for displaying multiple streams of data on a single screen for a user.

U.S. Pat. No. 6,960,987 B2, issued to Dohi et al. on Nov. 1, 2005, discloses a fire alarm system for connecting a plurality of fire sensors to sensor lines, and giving an alarm in response to fire information output from the fire sensor in a line unit. The fire alarm system includes a current modulation section and an address specification section. The current modulation section is used for maintaining a current flowing in the sensor line at a predetermined value for a predetermined time at the time of a fire, and modulating the current in accordance with the inherent address information of the fire sensor. The address specification section is used for sensing fire information by judging whether or not the current has been maintained at the predetermined value for the predetermined time, and also for specifying the inherent address of the fire sensor that issued the fire information, from the modulated state of the current.

U.S. Patent Publication No. 2006/0139160 A1, inventor Lin et al. published on Jun. 29, 2006, discloses a an intelligent AV type fire detection system for a large or high-rise building comprising smoke detectors, a controller, activated by any one smoke detector detecting a fire, alarms activated by the controller, image fetching devices wherein one image fetching device nearest the scene of fire is activated by the controller for generating an AV signal, and a communication module. The controller is adapted to generate an AV fire signal contained images from the scene of fire, and the communication module is adapted to receive the AV fire signal from the controller and transfer the AV fire signal to recipients including a fire department and a police department via a telephone company. The recipients thus can directly confirm whether a fire breaks out in a very short time, resulting in a saving of precious time for extinguishing fire.

While these patents and other previous methods have attempted to solve the problems that they addressed, none have utilized or disclosed a fire alarm system of addressable 120 volt smoke detectors in communication with the 24 volt addressable building alarm system, as does embodiments of the present invention.

Therefore, a need exists for a fire alarm system with these attributes and functionalities. The fire alarm system according to embodiments of the invention substantially departs from the conventional concepts and designs of the prior art. It can be appreciated that there exists a continuing need for a fire alarm system which can be used commercially. In this regard, the present invention substantially fulfills these objectives.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

In general, in one aspect, the invention features a fire alarm system where the unit detectors are addressable and in communication with other unit detectors located within a particular unit and are in communication with building detectors such that when one unit detector activates, all the other unit detectors in that unit also activate causing communication with the building core detectors and alerting the control room as to the exact location of the alarm condition.

In one implementation, the fire alarm system is comprised of 120 volt addressable unit smoke detectors in communication with 24 volt addressable building core detectors.

In another implementation, the unit smoke detectors are 24 volt addressable devices (smoke, heat, CO2, thermal, flame and ADA) that are in communication with the 24 volt addressable building core devices.

One advantage of the invention is that an addressable 120 volt detector not only alerts the tenant when something was wrong, but also alerts the building owner/security.

Another advantage of the invention is that it allows a high voltage contractor and a low voltage contractor to merge the two systems together, providing the owner/end user a cost effective solution in residential fire alarm system applications where both tenants and building owner/security office can respond to an emergency faster, knowing precisely which unit has detected a trouble condition.

Other objects, advantages and capabilities of the invention are apparent from the following description taken in conjunction with the accompanying drawings showing the preferred embodiment of the invention.

### BRIEF DESCRIPTION OF THE SEVERAL VIEWS OF THE DRAWINGS

The invention, together with further advantages thereof, may best be understood by reference to the following description of the simplest form of the invention, taken in conjunction with the accompanying drawings in which:

FIG. 1 illustrates a typical fire alarm system, where the unit detectors are not in communication with the building core detectors.

FIG. 2 illustrates a fire alarm system, where the unit detectors are addressable and in communication with the addressable building core detectors, according to an embodiment of the present invention.

FIG. 3 illustrates an example of a manual rotary address setting interface, according to an embodiment of the present invention.

### DETAILED DESCRIPTION OF THE INVENTION

The present invention will now be described in detail with reference to at least one preferred embodiment thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

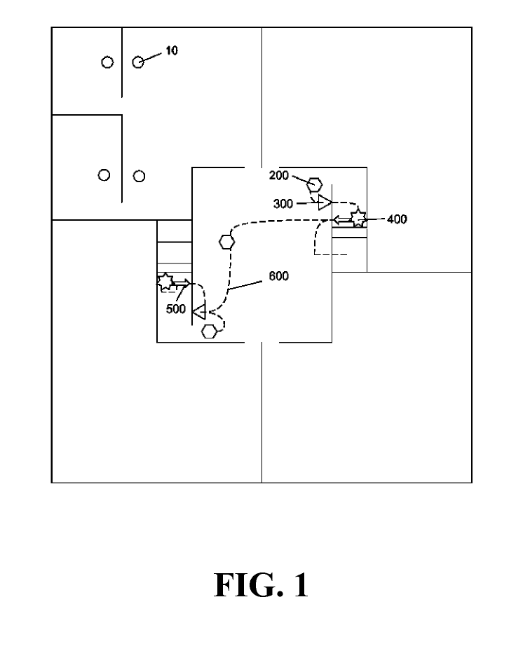

Referring to the drawings wherein like reference numerals designate corresponding parts throughout the several figures, reference is made first to FIG. 1 that illustrates a typical fire alarm system for a floor in a high rise condo building.

In FIG. 1, four of a 120 volt non-addressable smoke detector 10 is represented as deployed within a unit of a floor. The 120 volt non-addressable smoke detectors 10 are not connected to each other or to the building core fire alarm system. The building core fire alarm system is comprised of a 24 volt addressable smoke detector 200, a pull alarm 300, a sprinkler tamper 400 and a flow switch 500, all of which are connected by wiring 600.

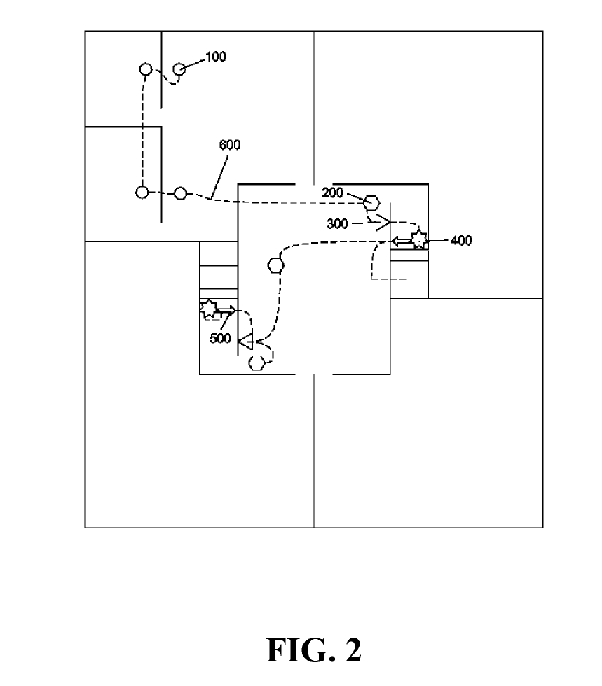

In FIG. 2, four of a 120 volt addressable smoke detector 100 is represented as deployed within a unit of a floor. The 120 volt addressable smoke detectors 100 are connected to each other and to the building core fire alarm system by wiring 600.

In a typical embodiment, when one of the 120 volt addressable smoke detectors 100 alarms, all of the 120 volt addressable smoke detectors 100 in the same unit also alarm, as well as the building core detectors.

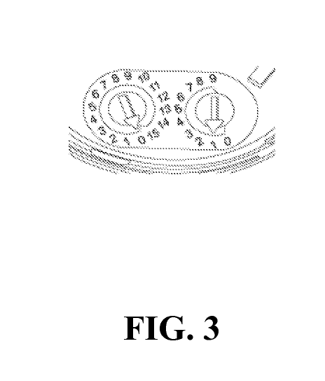

In FIG. 3, one possible design for associating an address with an addressable detector is shown. Other designs are possible, such as dip switches, key pads, and the like.

In an exemplary implementation a method of identifying an alarm condition within a unit of a building to a building core alarm system according an embodiment of the present invention is comprised of installing one of more of an addressable alarm condition unit detector within the unit; associating an address with the unit; setting the address on the at least one addressable alarm condition unit detector; and establishing a communication path between the addressable alarm condition unit detector(s) and the building core alarm system. Once example of the communication path is wiring. The method may be further comprised of transmitting the address of the addressable alarm condition unit detectors in the unit to the building core alarm system when an alarm condition is detected by one or more of the addressable alarm condition unit detectors. The addressable alarm condition unit detector may be 24 volt devices or 120 volt devices, depending on the embodiment. The 24 volt or 120 volt devices may be a smoke detector, a heat detector a CO2 detector, a thermal detector, a flame detector, an ADA strobe device, or any other device capable of detecting an alarm condition. The method may be further comprised of a building core alarm system that is comprised of a plurality of pull stations, sprinkler tampers, flow switches, fire phones and/or smoke detectors.

The foregoing description and drawings comprise illustrative embodiments of the present invention. Having thus described exemplary embodiments of the present invention, it should be noted by those skilled in the art that the within disclosures are exemplary only, and that various other alternatives, adaptations and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing description and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A method of identifying an alarm condition within a unit of a building to a building core alarm system comprising:
installing at least one addressable alarm condition unit detector within the unit;
associating an address with the unit;
setting the address on the at least one addressable alarm condition unit detector; and
establishing a communication path between the at least one addressable alarm condition unit detector and the building core alarm system.

2. The method as claimed in claim 1, further comprising transmitting the address of the at least one addressable alarm condition unit detector to the building core alarm system when an alarm condition is detected by the at least one addressable alarm condition unit detector.

3. The method as claimed in claim 2, wherein the communication path is wiring.

4. The method as claimed in claim 3, wherein the addressable alarm condition unit detector is a 24 volt device.

5. The method as claimed in claim 4, wherein the 24 volt device is a smoke detector.

6. The method as claimed in claim 4, wherein the 24 volt device is a heat detector.

7. The method as claimed in claim 4, wherein the 24 volt device is a CO2 detector.

8. The method as claimed in claim 4, wherein the 24 volt device is a thermal detector.

9. The method as claimed in claim 4, wherein the 24 volt device is a flame detector.

10. The method as claimed in claim 4, wherein the 24 volt device is an ADA strobe device.

11. The method as claimed in claim 4, wherein the building core alarm system is comprised of:
a plurality of pull stations;
a plurality of sprinkler tampers;
a plurality of flow switches;
a plurality of fire phones; and
a plurality of smoke detectors.

12. The method as claimed in claim 3, wherein the addressable alarm condition unit detector is a 120 volt device.

13. The method as claimed in claim 12, wherein the 120 volt device is a smoke detector.

14. The method as claimed in claim 12, wherein the 120 volt device is a heat detector.

15. The method as claimed in claim 12, wherein the 120 volt device is a CO2 detector.

16. The method as claimed in claim 12, wherein the 120 volt device is a thermal detector.

17. The method as claimed in claim 12, wherein the 120 volt device is a flame detector.

18. The method as claimed in claim 12, wherein the 120 volt device is an ADA strobe device.

19. The method as claimed in claim 12 wherein the building core alarm system is comprised of:
a plurality of pull stations;
a plurality of sprinkler tampers;
a plurality of flow switches;
a plurality of fire phones; and
a plurality of smoke detectors.
